(19) United States
(12) Patent Application Publication
(10) Pub. No.: US 2021/0288726 A1
(43) Pub. Date: Sep. 16, 2021

(54) LOCATION ACCURACY USING LOCAL TRANSMITTERS

(71) Applicant: Uber Technologies Inc., San Francisco, CA (US)

(72) Inventors: Dineshkumar Karuppanna Gounder Ramasamy, San Francisco, CA (US); Hemabh Shekhar, Los Gatos, CA (US); Saandeep Depatla, San Francisco, CA (US)

(21) Appl. No.: 17/249,389

(22) Filed: Mar. 1, 2021

Related U.S. Application Data
(60) Provisional application No. 62/988,709, filed on Mar. 12, 2020.

(51) Int. Cl. H04B 17/27; H04B 17/391; H04B 17/318; G01S 19/25; G01S 19/47; H04B 17/373

(52) U.S. Cl. CPC H04B 17/27; H04B 17/3913; H04B 17/373; G01S 19/252; G01S 19/47; H04B 17/318

(57) ABSTRACT

Systems and methods are provided for receiving a unique identifier for a local transmitter and a signal strength for the local transmitter, determining a position and channel parameters of the local transmitter based on the unique identifier for the local transmitter, converting the signal strength for the local transmitter into a distance measurement using the channel parameters, the distance measurement indicating a distance of a computing device to the position of the local transmitter, and calculating a location of the computing device using the distance measurement and position of the local transmitter.

### CLAIM FOR PRIORITY

This application claims the benefit of priority of U.S. Application Ser. No. 62/988,709, filed Mar. 12, 2020, which is hereby incorporated by reference in its entirety.

### BACKGROUND

Typically, location information is derived using a global positioning system (GPS). For example, a computing device, such as a mobile device, comprises a GPS receiver that receives signals from GPS satellites and the computing device uses the signals to calculate the location of the computing device. There are some situations, however, where a GPS signal can be weak or lost. Some examples of these situations include tunnels, parking garages, multi-lane highways, and the like.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some example embodiments.

FIG. 2 is a flowchart illustrating aspects of a method, according to some example embodiments.

FIG. 3 illustrates an example of a trajectory of a computing device, according to some example embodiments.

FIG. 4 is a flowchart illustrating aspects of a method, according to some example embodiments.

FIGS. 5A and 5B illustrate location data shown on two maps, according to some example embodiments.

FIG. 6 is a flowchart illustrating aspects of a method, according to some example embodiments.

FIG. 7 is a block diagram illustrating an example of a software architecture that may be installed on a machine, according to some example embodiments.

FIG. 8 illustrates a diagrammatic representation of a machine, in the form of a computer system, within which a set of instructions may be executed for causing the machine to perform any one or more of the methodologies discussed herein, according to an example embodiment.

### DETAILED DESCRIPTION

Systems and methods described herein relate to improving location estimates using local transmitters (e.g., short-range communication transmitters), such as Bluetooth low energy (BLE) beacons or Wi-Fi access points. As explained above, location information is typically derived using GPS. For example, a computing device, such as a mobile device, comprises a GPS receiver that receives signals from GPS satellites and uses the signals to calculate the position or location of the computing device. There are some situations, however, where a GPS signal can be weak or lost. Some examples of these situations include tunnels, parking garages, multi-lane highways, and the like. In some cases, an inertial measurement unit (IMU) on a computing device can be used to extrapolate in between GPS measurements, however, in places like tunnels and other locations where GPS signals are absent for long durations (e.g., over 100 meters), interpolation cannot be done accurately using the IMU.

Moreover, there are many critical systems, such as safety systems, traffic systems, and so forth where it is important to know a more precise location of a computing device (e.g., a smartphone of a user that is in distress or is in a car accident). There are also many other scenarios, like a ride-sharing scenario, where accurate location of riders and drivers is important to determine pickup and drop-off locations, fare information, safety and insurance, reporting and dispatch, and traffic and navigation information.

Example embodiments provide a system for mapping locations of local transmitters, such as BLE beacons, and using the local transmitters to determine a location of a computing device (e.g., a computing device associated with a driver, rider, pedestrian). For example, some cities and private companies install BLE beacons in tunnels and other locations to provide short-range communication and help with navigation in these locations. Example embodiments map locations of the BLE beacons and use the BLE beacon locations and signals received from the BLE beacons to determine a location of a computing device, as explained in further detail below.

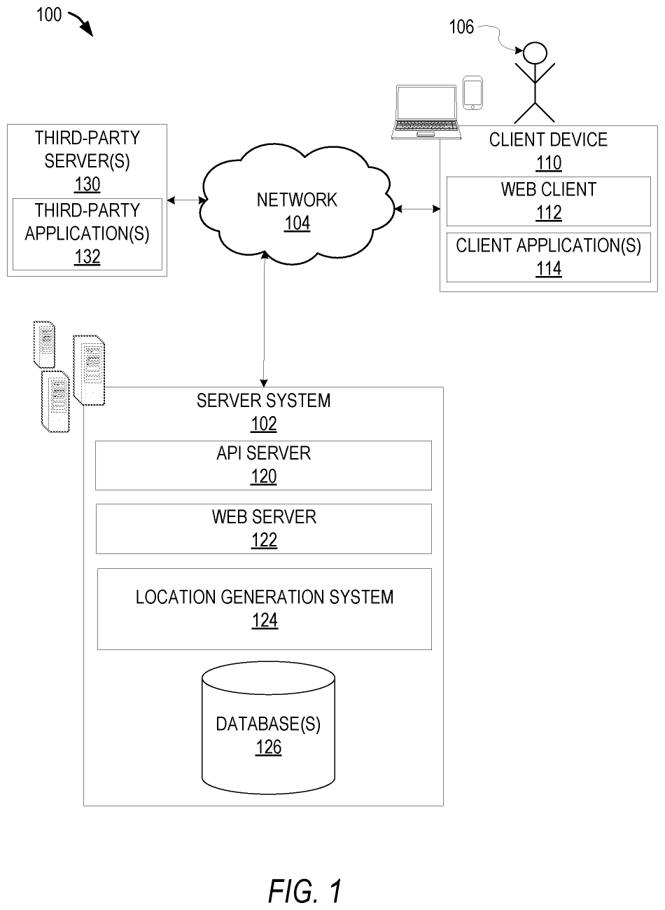

FIG. 1 is a block diagram illustrating a networked system 100, according to some example embodiments. The system 100 includes one or more client devices such as client device 110. The client device 110 may comprise, but is not limited to, a mobile phone, desktop computer, laptop, portable digital assistant (PDA), smart phone, tablet, ultrabook, netbook, laptop, multi-processor system, microprocessor-based or programmable consumer electronic, game console, set-top box, computer in a vehicle, or any other communication device that a user may utilize to access the networked system 100. In some embodiments, the client device 110 may comprise a display module (not shown) to display information (e.g., in the form of user interfaces). In further embodiments, the client device 110 may comprise one or more of touchscreens, accelerometers, gyroscopes, cameras, microphones, GPS devices, IMUS, and so forth. The client device 110 may be a device of a user that is used to request map information, provide map information, request navigation information, receive and display results of map and/or navigation information, request data about a place or entity in a particular location, receive and display data about a place or entity in a particular location, receive and display data about a pickup or drop-off location, receive and display data related to navigation to a pickup or drop-off location, and so forth.

One or more users 106 may be a person, a machine, or other means of interacting with the client device 110. In example embodiments, the user 106 is not part of the system 100 but interacts with the system 100 via the client device 110 or other means. For instance, the user 106 provides input (e.g., touchscreen input or alphanumeric input) to the client device 110 and the input may be communicated to other entities in the system 100 (e.g., third-party servers 130, server system 102) via a network 104. In this instance, the other entities in the system 100, in response to receiving the input from the user 106, communicate information to the client device 110 via the network 104 to be presented to the user 106. In this way, the user 106 interacts with the various entities in the system 100 using the client device 110. In some example embodiments, the user 106 is a rider in a ride-sharing service, a driver in a ride-sharing service, a person desiring information about a rider pick-up location, or the like.

The system 100 further includes the network 104. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WIFI network, a WiMax network, another type of network, or a combination of two or more such networks.

The client device 110 accesses the various data and applications provided by other entities in the system 100 via a web client 112 (e.g., a browser, such as the Internet Explorer® browser developed by Microsoft® Corporation of Redmond, Wash. State) or one or more client applications 114. The client device 110 includes the one or more client applications 114 (also referred to as “apps”) such as, but not limited to, a web browser, a messaging application, an electronic mail (email) application, an e-commerce site application, a mapping or location application, a ride-sharing application, a navigation application, and the like.

In some embodiments, the one or more client applications 114 may be included in the client device 110, and configured to locally provide a user interface and at least some of the functionalities, with the client applications 114 configured to communicate with other components or entities in the system 100 (e.g., third-party servers 130, server system 102), on an as-needed basis, for data and/or processing capabilities not locally available (e.g., to access location information, to request a pickup or drop-off location, to access navigation information, to authenticate the user 106, to verify a method of payment). Conversely, the one or more client applications 114 may not be included in the client device 110, and the client device 110 may use its web browser to access the one or more applications hosted on other entities in the system 100 (e.g., third-party servers 130, server system 102).

The server system 102 provides server-side functionality via the network 104 (e.g., the Internet or a wide area network (WAN)) to one or more third-party servers 130 and/or one or more client devices 110. The server system 102 may include an application programming interface (API) server 120, a web server 122, and a navigation system 124, that are communicatively coupled with one or more databases 126.

The one or more databases 126 are storage devices that store data related to one or more of source code, navigation data, pick-up and drop-off locations, a nearest node to a destination location, mapping and location information related to local transmitters (e.g., BLE beacons), and so forth. The one or more databases 126 may further store information related to the third-party servers 130, third-party applications 132, the client device 110, the client applications 114, the user 106, and so forth. The one or more databases 126 may be cloud-based storage.

The server system 102 is a cloud computing environment, according to some example embodiments. The server system 102, and any servers associated with the server system 102, are associated with a cloud-based application, in one example embodiment.

The location generation system 124 provides back-end support for the third-party applications 132 and the client applications 114, which may include cloud-based applications. The location generation system 124 maps locations of local transmitters, generates location data for a computing device using local transmitters, among other things, as described in further detail below. The location generation system 124 comprises one or more servers or other computing devices or systems.

The system 100 further includes one or more third-party servers 130. The one or more third-party servers 130 comprise one or more third-party applications 132. The one or more third-party applications 132, executing on the third-party server(s) 130, interact with the server system 102 via a programmatic interface provided by the API server 120. For example, the one or more third-party applications 132 may request and utilize information from the server system 102 via the API server 120 to support one or more features or functions on a website hosted by a third party or an application hosted by the third party. In one example, a third-party application 132 may request and receive navigation data via the server system 102 and the navigation system 124.

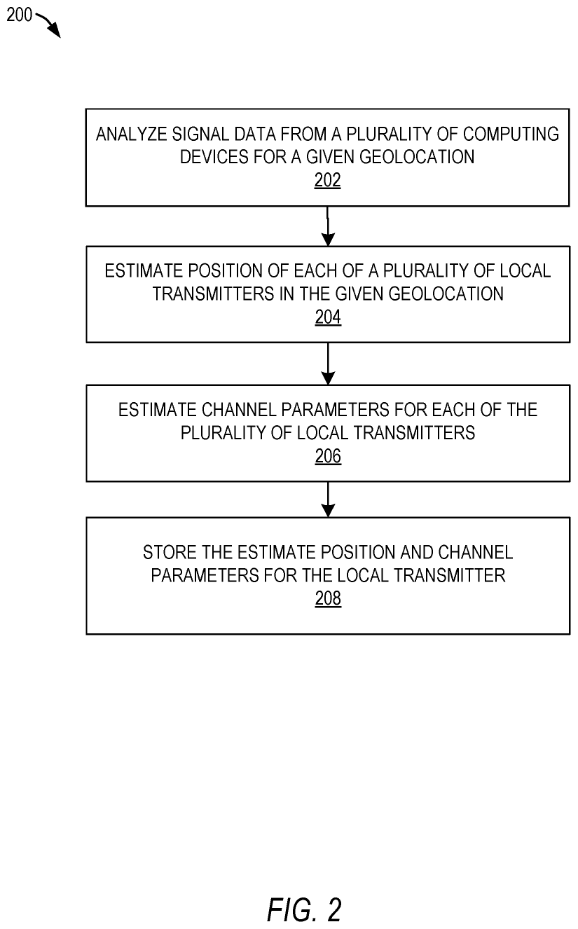

FIG. 2 is a flowchart illustrating aspects of a method 200 for generating location information for one or more local transmitter locations, according to some example embodiments. For illustrative purposes, the method 200 is described with respect to the networked system 100 of FIG. 1. It is to be understood that the method 200 may be practiced with other system configurations in other embodiments.

As explained above, example embodiments utilize local transmitters, such as BLE beacons, to improve location information of a computing device. To utilize such local transmitters, however, the location for each local transmitter needs to be determined. Since the local transmitters are often installed by private companies and in locations not easily or safely accessible, location information is not typically known and cannot be acquired manually. Accordingly, example embodiments described herein map out a location for each local transmitter individually.

In operation 202, one or more processors of a computing system (e.g., a server system, such as the server system 102 or the location generation system 124) analyzes signal data from a plurality of computing devices for a given geolocation. For example, a ride sharing company may have applications installed on a plurality of computing devices (e.g., client devices 110) that are regularly sending location data for requesting a location for a pickup location for a rider, for requesting navigation instructions, for notifying availability for a pickup, and so forth. Part of the data sent by such computing devices can be signal data related to local transmitters. A ride sharing company is just one example. It is understood that signal data can be received from computing devices in various use cases, such as mapping and navigation scenarios, safety and emergency services scenarios, and so forth. In one example embodiment, a predetermined period of signal data (e.g., twenty-four hours, a few days, a week) can be used for analysis and estimating a position of a local transmitter.

In one example, a local transmitter is a BLE beacon and the signal data emitted from the BLE beacon and received by a receiver in a computing device comprises a unique identifier for the BLE beacon, a timestamp, and a signal strength (e.g., received signal strength indicator (RSSI)).

A given geolocation may be any specified area where a location of local transmitters is desired. Some examples include inside tunnels, underground parking garages, multi-lane highways, and the like. The given geolocation may be determined based on analyzing location data to determine areas where signal is frequently lost, knowledge of location of tunnels and other such structures, or other means.

The data, including signal data related to transmitters, is received, by the computing system, from the plurality of computing devices, and stored in one or more data stores (e.g., database(s) 126). The computing system accesses the stored signal data and retrieves signal data corresponding to the given geolocation. For example, the computing system isolates signal data for computing devices passing through a given geolocation in a predetermined time period (e.g., the most recent few days). In some example embodiments, GPS, IMU (e.g., gyroscope, accelerometer), and other location or movement-related data corresponding to the given location is also retrieved.

In operation 204, the computing system estimates a position (e.g., geographical coordinates, such as latitude and longitude) for each of a plurality of local transmitters in the given location. The computing system estimates the position using trajectories through the geolocation with low or non-existent GPS coverage. Accordingly, the computing system extracts trajectories through the geolocation using GPS, IMU data (e.g., accelerometer and gyroscope data), and signal data for local transmitters.

A trajectory is a path of a computing device through a geolocation. For example, a computing device (e.g., smartphone or computer in car) may be located in a car that is driving through a tunnel that has low or non-existent GPS coverage. In this example, the trajectory is the path or route of the car from a start point in or before the tunnel to an end point at the end or after the tunnel (the geolocation). In one example embodiment, map data can be used to snap a trajectory to a road. For example, if the road through the tunnel is known, the trajectory can be snapped to the road to increase accuracy.

To estimate the position of a local transmitter, the computing system can determine the position or location of the computing device (e.g., in a car) in a predetermined number of time instances (e.g., three) in the trajectory. For example, the computing system can determine the position of the computing device x1, y1 (latitude, longitude) at t1 (time), x2, y2 at t2, and x3, Y3 at t3. For example, the computing system can estimate the position of the computing device using GPS, IMU, and/or map data. Since the computing system initially has no estimates for the local transmitter, the computing device uses GPS, IMU, and/or map data. IMU data can fill in for absent GPS for a while, however, estimate errors increase with distance traveled without GPS. In one example embodiment, the computing system takes portions of trajectories that have low estimated location errors to estimate a position of a local transmitter.

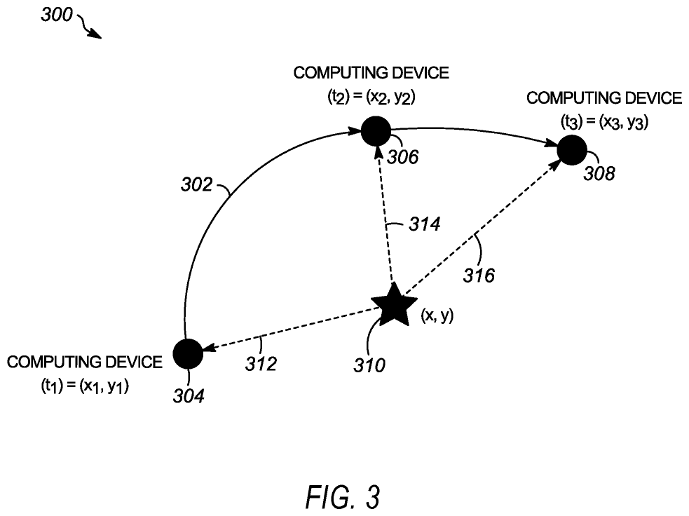

The computing device can then determine the signal strength (e.g., RSSI values) at each of the time instances (e.g., t1, t2, t3) received by the computing device from a local transmitter. FIG. 3 illustrates an example 300 of a trajectory 302 (e.g., from 304-308), and three time instances t1 (304), t2 (306), and t3 (308). The example 300 further illustrates a local transmitter 310 emitting signals 312, 314, and 316 (e.g., RSSI) that are received by the computing device. While the example 300 shows one trajectory, it is to be understood that multiple trajectories can be used in example embodiments. The following description uses one trajectory to estimate a position of a local transmitter and channel parameters for the local transmitter. It is to be understood that multiple trajectories can be identified for the geolocation and used to generate an estimated position and channel parameter of the local transmitter.

The computing system can then determine a distance of the computing device from the local transmitter in each of the predefined (e.g., three) time instances to estimate the position of the local transmitter.

To determine the distance to the local transmitter or range sample, the computing system converts the signal data received from the local transmitter (e.g., RSSI data) to range sample or distance. For example, the computing system takes the RSSI value, which is an indicator of the strength of the received signal strength, and converts it to a range sample. The signal strength, such as an RSSI value, is an indirect measure of how far away the receiver (e.g., computing device) is from the local transmitter. When the receiver is close to the local transmitter, the signal or RSSI value will be higher and as the receiver gradually moves away from the local transmitter, the signal or RSSI value decreases. The dependence of RSSI value on distance from the local transmitter can be modelled using the following equation:

P(d)=α+10β log 10(d)

where P(d) is the nominal measure RSSI at distance d meters from the local transmitter (e.g., BLE beacon) and α and β are BLE beacon specific wireless channel parameters that need to be estimated. For example, P(d) is the received power in decibel (dB) scale at distance d in dBm, d is the distance from the BLE beacon in meters, channel parameter α is the received power at in decibels (dB) at one meter which can be different for each beacon and can account for battery life, and channel parameter β is the rate at which the received power decreases as a receiver moves away from the BLE beacon (e.g., pass loss exponent which can be different for each BLE beacon and can account for channel conditions). Typical values for channel parameters are α=−6 dB and β=2.

Computing devices have no knowledge of the parameters α and β and can only reliably report the received power measurements. Accordingly, in operation 206, the computing system estimates the channel parameters α and β for the local transmitter. Multiple received power measurements from the same transmitter leads to a system of equations P(di)=alpha+10 beta log (di) where i=1, 2, 3 . . . , N. N is the number of measurements. The computing system can then solve this system of equations to estimate alpha, beta, along with the location of the transmitting device (e.g., using a Monte Carlo estimator).

Once the computing system has the estimated parameters α and β, the computing system can convert the RSSI value to distance (d) from the local transmitter. In one example, the following formula can be used:

$$d = {10}^{\frac{rssi - α}{10 β}}$$

The computing system generates the estimated position of the local transmitter using the position of the computing device (e.g., at t1, t2, and t3) and the distance of the computing device from the local transmitter (e.g., at t1, t2, t3). The generated estimated position comprises geographical coordinates (e.g., latitude, longitude) of the local transmitter.

In operation 208, the computing system stores the estimate position and channel parameters for the local transmitter. For example, the computing system stores the unique identifier, the latitude and longitude, and the channel parameters α and β in one or more database(s) 126. The position (e.g., latitude, longitude) and the channel parameters (e.g., α and β) can then be used to improve location accuracy of a computing device, as explained below.

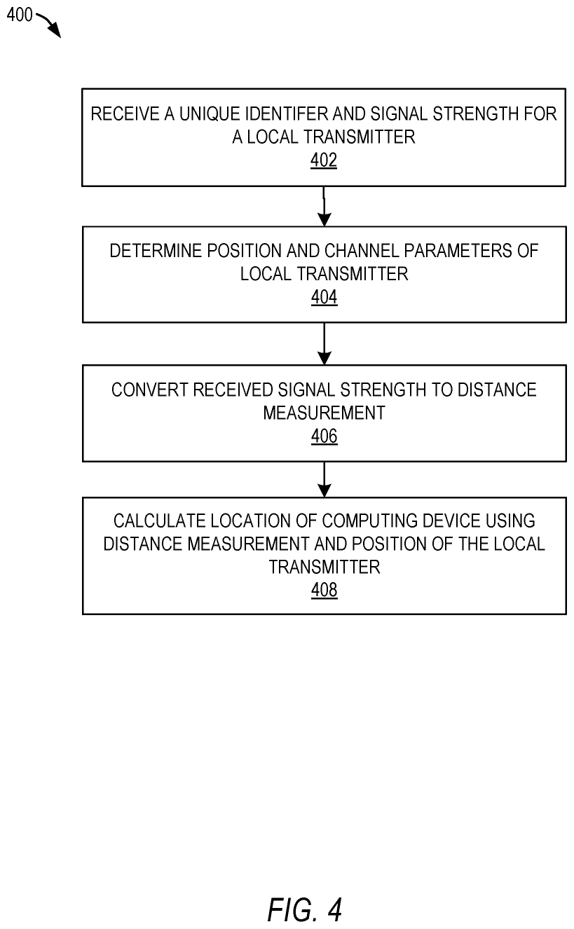

FIG. 4 is a flowchart illustrating aspects of a method 400 for generating location information for a computing device using signal data from a local transmitter, according to some example embodiments. For illustrative purposes, the method 400 is described with respect to the networked system 100 of FIG. 1. It is to be understood that the method 400 may be practiced with other system configurations in other embodiments.

In operation 402, a computing device (e.g., client device 110) receives a unique identifier for a local transmitter and a signal strength for the local transmitter. For example, the computing device may be in a car driving through a tunnel. As the car is driving through the tunnel, the computing device is receiving signal data for one or more local transmitters installed in the tunnel. In one example, the local transmitter is a BLE beacon and the signal data is received by a Bluetooth receiver of the computing device and includes a unique identifier of the local transmitter, an RSSI value, and a timestamp.

In operation 404, the computing device determines a position and channel parameters of the local transmitter based on the unique identifier of the local transmitter. As explained above, position information (e.g., geographical coordinates) of the local transmitter is estimated and stored in one or more data stores (e.g., database(s) 126). The computing device accesses the data store or requests the data via a computing system (e.g., server system 102 or location generation system 124). The computing device receives (e.g., from the data store or via the computing system) the position and channel parameters corresponding to the unique identifier.

In operation 406, the computing device converts the signal strength for the local transmitter into a distance measurement using the channel parameters. The distance measurement indicates the distance of the computing device to the position (e.g., geographic coordinates, such as latitude and longitude) of the local transmitter. In one example embodiment, the computing device converts the RSSI into a log of distance to generate the distance measurement indicating the distance of the computing device to the position of the local transmitter.

In one example embodiment, as explained in detail above, the computing device converts the signal strength (e.g., RSSI value) for the local transmitter into a distance measurement (using the channel parameters α and β) by using the following formula:

$$d = {10}^{\frac{rssi - α}{10 β}}$$

In operation 408, the computing device calculates a location (e.g., latitude/longitude) of the computing device using the distance measurement and position of the local transmitter. For example, the computing device determines the location of the computing device based on how far it is to the position of the local transmitter.

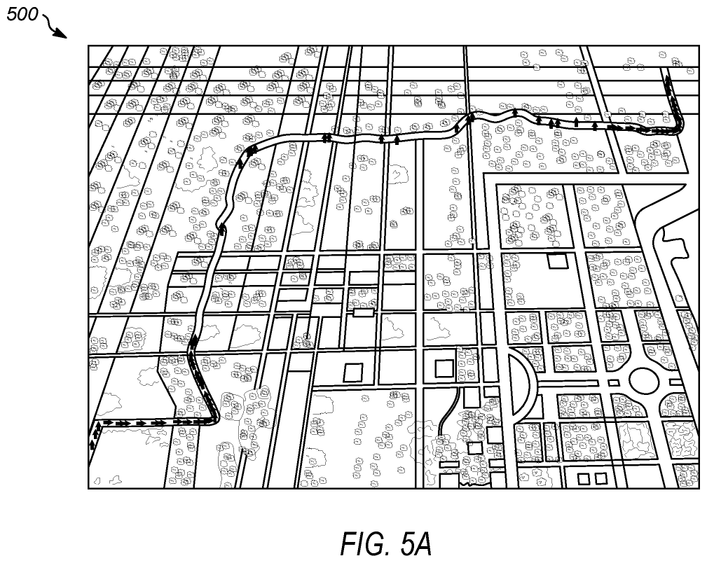

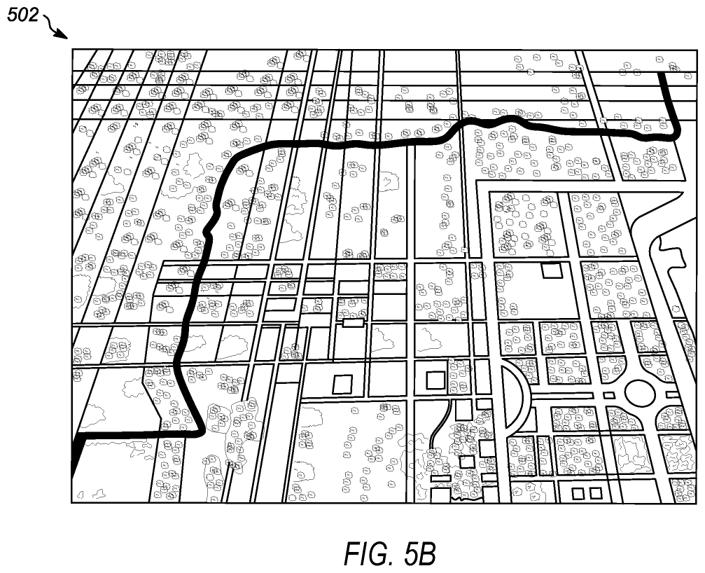

In one example, the computing device uses multiple signal data, such as GPS, IMU, and local transmitter to generate the location of the computing device. FIGS. 5A and 5B illustrate two maps 500 and 502. The map 500 shows various locations of a computing device in a car driving along Wacker Drive in Chicago based on only GPS data. As can be seen there are only sporadic points shown through the tunnel indicating locations of the car. The map 502 shows locations of a computing device in a car driving along Wacker Drive in Chicago using GPS, IMU, and local transmitter data. As can be seen, the coverage of locations of the car along Wacker Drive is almost one hundred percent and accurately traverses the path the car is driving. In this way, example embodiments improve both accuracy and availability of location data for computing devices.

As mentioned above, the calculated location of the computing device can be used for navigation, generating pickup and drop-off locations for a rider and driver, for safety services, to determine drivers in an area for a ride request, and so forth. For instance, the computing device uses the calculated location of the computing device to request navigation information, to display a position of the computing device (or user or car) on a map, and so forth. The scenario of a computing device in a car is described as an example herein, however, it is to be understood that a location of any computing device can be determined using the methods described herein. For example, a location of a computing device being carried by a user can be determined when a user is walking, biking, on a scooter, or traveling by other transportation means.

In another example embodiment, local transmitters, such as BLE beacons, can be used to locate assets. Some example assets comprise scooters, bikes, and the like. These assets can have BLE beacons associated with them, for example, embedded in the hardware of the asset. In some scenarios, an asset may be parked in a location that does not have a GPS signal, such as in a parking garage, in a tunnel, inside a large building, or other location. Example embodiments can determine the location of the asset using signals received by computing devices in the area of the position of the asset. For example, the computing system can determine that a computing device was at a particular geographic location (e.g., latitude/longitude) when it received a signal (e.g., RSSI) corresponding to a unique identifier of a BLE beacon associated with the asset.

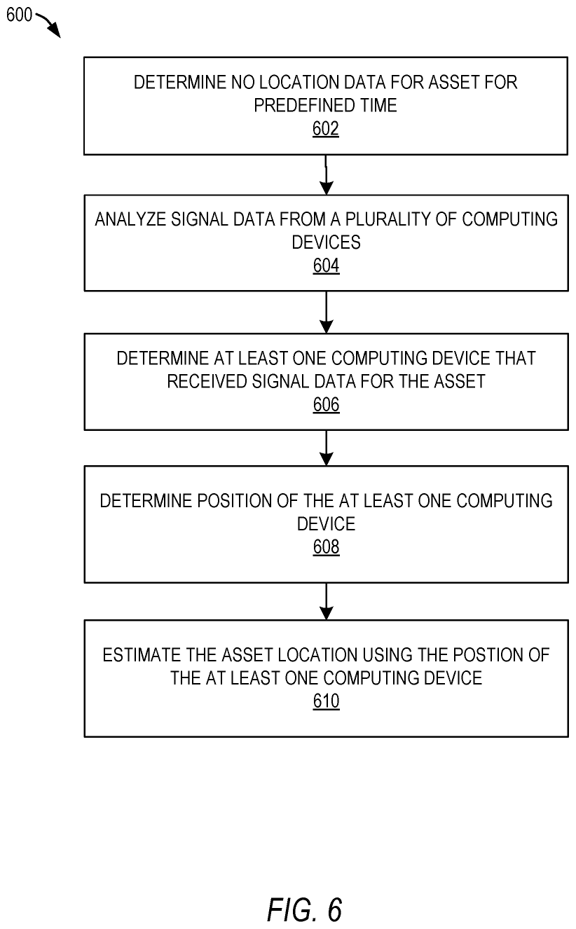

FIG. 6 is a flowchart illustrating aspects of a method 600 for locating an asset using signal data from a local transmitter, according to some example embodiments. For illustrative purposes, the method 600 is described with respect to the networked system 100 of FIG. 1. It is to be understood that the method 600 may be practiced with other system configurations in other embodiments.

In operation 602, a computing system (e.g., server system 102 or location generation system 124) determines that no location information has been observed for an asset for a predefined period of time (e.g., 30 minutes, 1 hour). For example, the computing system may regularly (e.g., every few minutes) receive location data from each of a plurality of assets and determine that location data for a particular asset has not been received in 30 minutes. Alternatively, the computing system can receive a request to locate a missing asset or an asset for which location information is not available.

In operation 604, the computing system analyzes signal data from a plurality of computing devices to determine if any computing devices have received signal data corresponding to the unique identifier of the BLE beacon associated with the asset. In one example, the computing system analyzes signal data for a geographical area (e.g., city or neighborhood) where the asset is most likely located to minimize the amount of signal data to analyze.

In operation 606, the computing system determines that at least one computing device has received a signal corresponding to the unique identifier of the BLE beacon associated with the asset. In operation 608, the computing system determines the position (e.g., latitude/longitude) of at least one computing device that has received the signal data corresponding to the unique identifier of the BLE beacon associated with the asset and uses that position as an estimated location for the asset, in operation 610. The computing device can determine the position of the computing device based on GPS or other location data.

The computing system can provide the location for the asset to a computing device or other computing system as the current location of the asset. This allows an asset to be found that may have been stolen, misplaced, or in an asset-sharing scenario (e.g., bike or scooter-sharing) where other users are looking for a bike or scooter to use.

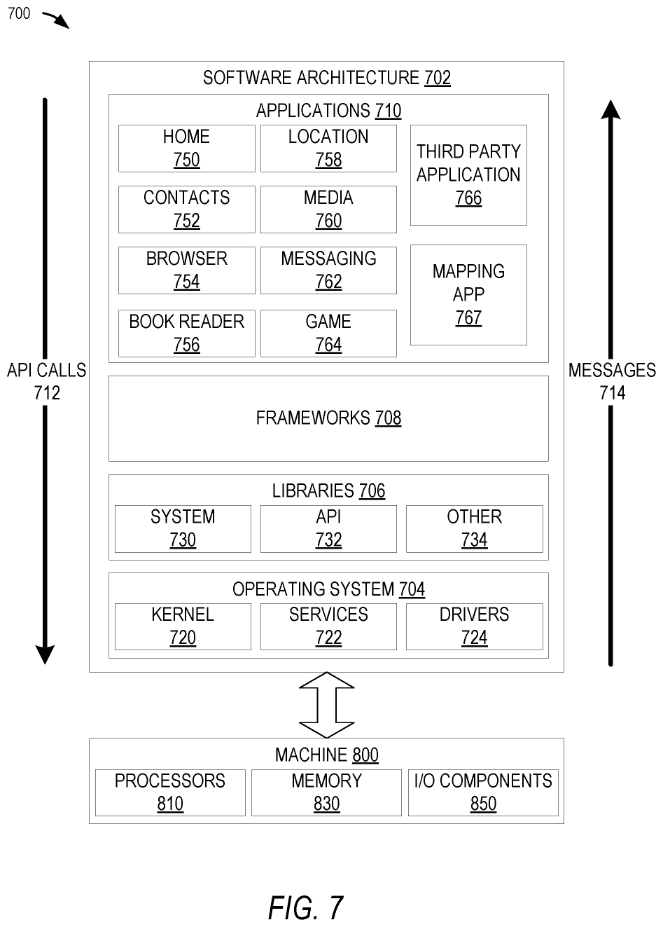

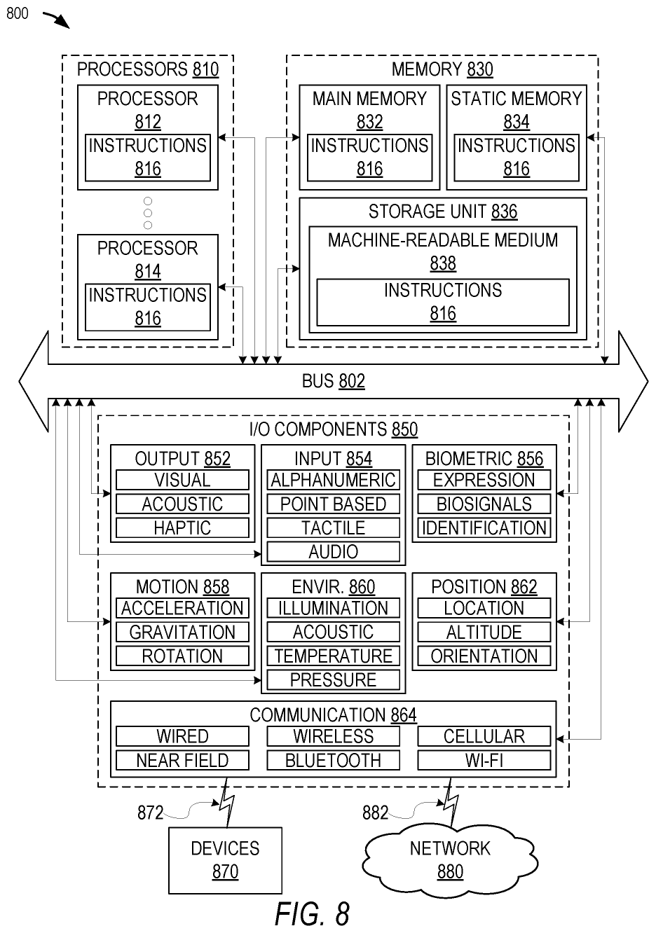

FIG. 7 is a block diagram 700 illustrating a software architecture 702, which can be installed on any one or more of the devices described above. For example, in various embodiments, client devices 110 and servers and systems 130, 102, 120, 122, and 124 may be implemented using some or all of the elements of the software architecture 702. FIG. 7 is merely a non-limiting example of a software architecture, and it will be appreciated that many other architectures can be implemented to facilitate the functionality described herein. In various embodiments, the software architecture 702 is implemented by hardware such as a machine 800 of FIG. 8 that includes processors 810, memory 830, and input/output (I/O) components 850. In this example, the software architecture 702 can be conceptualized as a stack of layers where each layer may provide a particular functionality. For example, the software architecture 702 includes layers such as an operating system 704, libraries 706, frameworks 708, and applications 710. Operationally, the applications 710 invoke application programming interface (API) calls 712 through the software stack and receive messages 714 in response to the API calls 712, consistent with some embodiments.

In various implementations, the operating system 704 manages hardware resources and provides common services. The operating system 704 includes, for example, a kernel 720, services 722, and drivers 724. The kernel 720 acts as an abstraction layer between the hardware and the other software layers, consistent with some embodiments. For example, the kernel 720 provides memory management, processor management (e.g., scheduling), component management, networking, and security settings, among other functionality. The services 722 can provide other common services for the other software layers. The drivers 724 are responsible for controlling or interfacing with the underlying hardware, according to some embodiments. For instance, the drivers 724 can include display drivers, camera drivers, BLUETOOTH® or BLUETOOTH® Low Energy drivers, flash memory drivers, serial communication drivers (e.g., Universal Serial Bus (USB) drivers), WIFI® drivers, audio drivers, power management drivers, and so forth.

In some embodiments, the libraries 706 provide a low-level common infrastructure utilized by the applications 710. The libraries 706 can include system libraries 730 (e.g., C standard library) that can provide functions such as memory allocation functions, string manipulation functions, mathematical functions, and the like. In addition, the libraries 706 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and in three dimensions (3D) graphic content on a display), database libraries (e.g., SQLite to provide various relational database functions), web libraries (e.g., WebKit to provide web browsing functionality), and the like. The libraries 706 can also include a wide variety of other libraries 734 to provide many other APIs to the applications 710.

The frameworks 708 provide a high-level common infrastructure that can be utilized by the applications 710, according to some embodiments. For example, the frameworks 708 provide various graphic user interface (GUI) functions, high-level resource management, high-level location services, and so forth. The frameworks 708 can provide a broad spectrum of other APIs that can be utilized by the applications 710, some of which may be specific to a particular operating system 704 or platform.

In an example embodiment, the applications 710 include a home application 750, a contacts application 752, a browser application 754, a book reader application 756, a location application 758, a media application 760, a messaging application 762, a game application 764, and a broad assortment of other applications, such as a third-party application 766. According to some embodiments, the applications 710 are programs that execute functions defined in the programs. Various programming languages can be employed to create one or more of the applications 710, structured in a variety of manners, such as object-oriented programming languages (e.g., Objective-C, Java, or C++) or procedural programming languages (e.g., C or assembly language). In a specific example, the third-party application 766 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 766 can invoke the API calls 712 provided by the operating system 704 to facilitate functionality described herein.

Some embodiments may particularly include a mapping application 767. In certain embodiments, this may be a standalone application that operates to manage communications with a server system such as third-party servers 130 or server system 102. In other embodiments, this functionality may be integrated with another application (e.g., a ridesharing, asset location, or navigation application). The mapping application 767 may request and display various data related to mapping and navigation and may provide the capability for a user 106 to input data related to the objects via a touch interface, via a keyboard, or using a camera device of the machine 800; communicate with a server system via the I/O components 850; and receive and store object data in the memory 830. Presentation of information and user inputs associated with the information may be managed by the mapping application 767 using different frameworks 708, library 706 elements, or operating system 704 elements operating on the machine 800.

FIG. 8 is a block diagram illustrating components of a machine 800, according to some embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 816 (e.g., software, a program, an application 710, an applet, an app, or other executable code) for causing the machine 800 to perform any one or more of the methodologies discussed herein can be executed. In alternative embodiments, the machine 800 operates as a standalone device or can be coupled (e.g., networked) to other machines. In a networked deployment, the machine 800 may operate in the capacity of a server machine or system 130, 102, 120, 122, 124, etc., or a client device 110 in a server-client network environment, or as a peer machine in a peer-to-peer (or distributed) network environment. The machine 800 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

In various embodiments, the machine 800 comprises processors 810, memory 830, and I/O components 850, which can be configured to communicate with each other via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 812 and a processor 814 that may execute the instructions 816. The term “processor” is intended to include multi-core processors 810 that may comprise two or more independent processors 812, 814 (also referred to as “cores”) that can execute instructions 816 contemporaneously. Although FIG. 8 shows multiple processors 810, the machine 800 may include a single processor 810 with a single core, a single processor 810 with multiple cores (e.g., a multi-core processor 810), multiple processors 812, 814 with a single core, multiple processors 812, 814 with multiple cores, or any combination thereof.

The memory 830 comprises a main memory 832, a static memory 834, and a storage unit 836 accessible to the processors 810 via the bus 802, according to some embodiments. The storage unit 836 can include a machine-readable medium 838 on which are stored the instructions 816 embodying any one or more of the methodologies or functions described herein. The instructions 816 can also reside, completely or at least partially, within the main memory 832, within the static memory 834, within at least one of the processors 810 (e.g., within the processor's cache memory), or any suitable combination thereof, during execution thereof by the machine 800. Accordingly, in various embodiments, the main memory 832, the static memory 834, and the processors 810 are considered machine-readable media 838.

As used herein, the term “memory” refers to a machine-readable medium 838 able to store data temporarily or permanently and may be taken to include, but not be limited to, random-access memory (RAM), read-only memory (ROM), buffer memory, flash memory, and cache memory. While the machine-readable medium 838 is shown, in an example embodiment, to be a single medium, the term “machine-readable medium” should be taken to include a single medium or multiple media (e.g., a centralized or distributed database, or associated caches and servers) able to store the instructions 816. The term “machine-readable medium” shall also be taken to include any medium, or combination of multiple media, that is capable of storing instructions (e.g., the instructions 816) for execution by a machine (e.g., the machine 800), such that the instructions, when executed by one or more processors of the machine (e.g., the processors 810), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 850 include a wide variety of components to receive input, provide output, produce output, transmit information, exchange information, capture measurements, and so on. In general, it will be appreciated that the I/O components 850 can include many other components that are not shown in FIG. 8. The I/O components 850 are grouped according to functionality merely for simplifying the following discussion, and the grouping is in no way limiting. In various example embodiments, the I/O components 850 include output components 852 and input components 854. The output components 852 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 854 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touchscreen that provides location and force of touches or touch gestures, or other tactile input components), audio input components (e.g., a microphone), and the like.

In some further example embodiments, the I/O components 850 include biometric components 856, motion components 858, environmental components 860, or position components 862, among a wide array of other components. For example, the biometric components 856 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 include acceleration sensor components (e.g., accelerometer), gravitation sensor components, rotation sensor components (e.g., gyroscope), and so forth. The environmental components 860 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 862 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 850 may include communication components 864 operable to couple the machine 800 to a network 880 or devices 870 via a coupling 882 and a coupling 872, respectively. For example, the communication components 864 include a network interface component or another suitable device to interface with the network 880. In further examples, the communication components 864 include wired communication components, wireless communication components, cellular communication components, near field communication (NFC) components, BLUETOOTH® components (e.g., BLUETOOTH® Low Energy), WI-FT® components, and other communication components to provide communication via other modalities. The devices 870 may be another machine 800 or any of a wide variety of peripheral devices (e.g., a peripheral device coupled via a Universal Serial Bus (USB)).

Moreover, in some embodiments, the communication components 864 detect identifiers or include components operable to detect identifiers. For example, the communication components 864 include radio frequency identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D barcodes, and other optical codes), acoustic detection components (e.g., microphones to identify tagged audio signals), or any suitable combination thereof. In addition, a variety of information can be derived via the communication components 864, such as location via Internet Protocol (IP) geo-location, location via WI-FT® signal triangulation, location via detecting a BLUETOOTH® or NFC beacon signal that may indicate a particular location, and so forth.

In various example embodiments, one or more portions of the network 880 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WIFI® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 816 are transmitted or received over the network 880 using a transmission medium via a network interface device (e.g., a network interface component included in the communication components 864) and utilizing any one of a number of well-known transfer protocols (e.g., Hypertext Transfer Protocol (HTTP)). Similarly, in other example embodiments, the instructions 816 are transmitted or received using a transmission medium via the coupling 872 (e.g., a peer-to-peer coupling) to the devices 870. The term “transmission medium” shall be taken to include any intangible medium that is capable of storing, encoding, or carrying the instructions 816 for execution by the machine 800, and includes digital or analog communications signals or other intangible media to facilitate communication of such software.

Furthermore, the machine-readable medium 838 is non-transitory (in other words, not having any transitory signals) in that it does not embody a propagating signal. However, labeling the machine-readable medium 838 “non-transitory” should not be construed to mean that the medium is incapable of movement; the machine-readable medium 838 should be considered as being transportable from one physical location to another. Additionally, since the machine-readable medium 838 is tangible, the machine-readable medium 838 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
receiving, by a computing device, a unique identifier for a local transmitter and a signal strength for the local transmitter;
determining, by the computing device, a position and channel parameters of the local transmitter based on the unique identifier for the local transmitter;
converting, by the computing device, the signal strength for the local transmitter into a distance measurement using the channel parameters, the distance measurement indicating a distance of the computing device to the position of the local transmitter; and
calculating, by the computing device, a location of the computing device using the distance measurement and position of the local transmitter.

2. The method of claim 1, wherein the local transmitter is a Bluetooth low energy beacon.

3. The method of claim 1, wherein the signal strength for the local transmitter is a received signal strength indicator (RSSI) comprising an estimated measure of the strength of the signal received from the local transmitter.

4. The method of claim 3, wherein converting the signal strength for the local transmitter into a distance measurement comprises converting the RSSI into a log of distance to generate the distance measurement indicating the distance of the computing device to geographic coordinates of the local transmitter.

5. The method of claim 1, wherein before receiving the unique identifier and signal strength for the local transmitter, a computing system estimates, for a given geolocation, a position for each of a plurality of local transmitters, including the local transmitter, estimates the channel parameters for each of the plurality of local transmitters, and stores the estimated position and channel parameters of the local transmitter.

6. The method of claim 5, wherein the position for each of the plurality of local transmitters for the given location are estimated using signal data from a plurality of computing devices in the given geolocation.

7. The method of claim 6, wherein the channel parameters for each of the plurality of local transmitters are estimated by assimilating the signal data from the plurality of computing devices in the given geolocation.

8. The method of claim 1, wherein the channel parameters of the local transmitter comprise an alpha parameter comprising a received power in decibels (dB) at distance of one meter and a beta parameter comprising a rate at which the received power decreases as a computing device moves away from the local transmitter.

9. The method of claim 1, wherein calculating the location of the computing device using the distance measurement and position of the local transmitter further comprises using global positioning system (GPS) and inertial measurement unit (IMU) data from the computing device.

10. The method of claim 1, further comprising:
generating navigation instructions based on the calculated location of the computing device.

11. A computing device comprising:
a memory that stores instructions; and
one or more processors configured by the instructions to perform operations comprising:
receiving a unique identifier for a local transmitter and a signal strength for the local transmitter;
determining a position and channel parameters of the local transmitter based on the unique identifier for the local transmitter;
converting the signal strength for the local transmitter into a distance measurement using the channel parameters, the distance measurement indicating a distance of the computing device to the position of the local transmitter; and
calculating a location of the computing device using the distance measurement and position of the local transmitter.

12. The computing device of claim 11, wherein the local transmitter is a Bluetooth low energy beacon.

13. The computing device of claim 11, wherein the signal strength for the local transmitter is a received signal strength indicator (RSSI) comprising an estimated measure of the strength of the signal received from the local transmitter.

14. The computing device of claim 13, wherein converting the signal strength for the local transmitter into a distance measurement comprises converting the RSSI into a log of distance to generate the distance measurement indicating the distance of the computing device to geographic coordinates of the local transmitter.

15. The computing device of claim 11, wherein before receiving the unique identifier and signal strength for the local transmitter, a computing system estimates, for a given geolocation, a position for each of a plurality of local transmitters, including the local transmitter, estimates the channel parameters for each of the plurality of local transmitters, and stores the estimated position and channel parameters of the local transmitter.

16. The computing device of claim 15, wherein the positions for each of the plurality of local transmitters for the given location are estimated using signal data from a plurality of computing devices in the given geolocation.

17. The computing device of claim 16, wherein the channel parameters for each of the plurality of local transmitters are estimated by assimilating the signal data from the plurality of computing devices in the given geolocation.

18. The computing device of claim 11, wherein the channel parameters of the local transmitter comprise an alpha parameter comprising a received power in decibels (dB) at distance of one meter and a beta parameter comprising a rate at which the received power decreases as a computing device moves away from the local transmitter.

19. The computing device of claim 11, wherein calculating the location of the computing device using the distance measurement and position of the local transmitter further comprises using global positioning system (GPS) and inertial measurement unit (IMU) data from the computing device.

20. A non-transitory computer-readable medium comprising instructions stored thereon that are executable by at least one processor to cause a computing system to perform operations comprising:
receiving a unique identifier for a local transmitter and a signal strength for the local transmitter;
determining a position and channel parameters of the local transmitter based on the unique identifier for the local transmitter;
converting the signal strength for the local transmitter into a distance measurement using the channel parameters, the distance measurement indicating a distance of the computing device to the position of the local transmitter; and
calculating a location of the computing device using the distance measurement and position of the local transmitter.
